(19) United States
(12) Patent Application Publication
(10) Pub. No.: US 2009/0092800 A1
(43) Pub. Date: Apr. 9, 2009

(54) COMPOSITION FOR PREPARING MODIFIED POLYIMIDE/CLAY NANOCOMPOSITES AND PREPARATION METHOD OF MODIFIED POLYMIDE/CLAY NANOCOMPOSITES USING THE SAME

(75) Inventors: Yoo Seung YANG, Daejeon (KR); Myung Sup JUNG, Seongnam-si (KR); Chung Kun CHO, Suwon-si (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); SAMSUNG ELECTRO-MECHANICS CO., LTD., Suwon-si (KR); SAMSUNG FINE CHEMICALS CO., LTD, Ulsan (KR)

(21) Appl. No.: 12/098,797

(22) Filed: Apr. 7, 2008

(30) Foreign Application Priority Data
Oct. 8, 2007 (KR) 10-2007-0100976

(51) Int. Cl. C08K 3/34; B32B 3/10

(52) U.S. Cl. 428/195.1; 524/445; 428/458

(57) ABSTRACT

Example embodiments provide a composition for preparing modified polyimide/clay nanocomposites. The composition comprises a modified polyamic acid terminated with groups at both ends of the backbone and a layered clay compound. Example embodiments provide a method for preparing modified polyimide/clay nanocomposites using the composition. Polyimide/clay nanocomposites prepared by the method exhibit excellent thermal properties. Therefore, the polyimide/clay nanocomposites can find many useful applications as materials for next-generation substrates that are small in size and thickness and light in weight.

### PRIORITY STATEMENT

This application claims priority under U.S.C. § 119 to Korean Patent Application No. 10-2007-100976, filed on Oct. 8, 2007, in the Korean Intellectual Property Office (KIPO), the entire contents of which are incorporated herein by reference.

### BACKGROUND

1. Field

Example embodiments relate to a composition for preparing modified polyimide/clay nanocomposites and a method for preparing modified polyimide/clay nanocomposites using the composition. Other example embodiments relate to a composition for the preparation of modified polyimide/clay nanocomposites which comprises a modified polyamic acid terminated with reactive groups at both ends of the backbone and a layered clay compound, and a method for preparing modified polyimide/clay nanocomposites using the composition.

2. Description of the Related Art

With a drastic increase in the complexity of electronic devices, many portions of interconnection wires are replaced by circuit boards. Further, flexible printed circuit (FPC) boards are rapidly replacing conventional printed circuit boards (PCBs) as electronic devices are becoming gradually smaller in size and thickness, lighter in weight and more integrated. Particularly, since cellular phones, notebook computers, camcorders, liquid crystal displays (LCDs), etc. have been introduced in the market, the market for flexible substrates has been showing remarkable growth.

Bismaleimide-triazine (BT) and glass epoxy resins (e.g., FR-4) are mainly used as substrate materials. However, these materials are not successful in providing satisfactory results, such as low dielectric properties, high heat resistance, low thermal expansion properties and low moisture absorption properties, for future packaging technologies. Thus, there is a need to develop novel materials that meet the requirements for next-generation substrates.

### SUMMARY

Accordingly, example embodiments have been made to provide a composition for preparing modified polyimide/clay nanocomposites. Example embodiments provide a method for preparing modified polyimide/clay nanocomposites. Example embodiments also provide a substrate with improved heat resistance and reduced thermal expansion that is produced using modified polyimide/clay nanocomposites prepared by the method.

### BRIEF DESCRIPTION OF THE DRAWINGS

Example embodiments will be more clearly understood from the following detailed description taken in conjunction with the accompanying drawings. FIGS. 1-6 represent non-limiting, example embodiments as described herein.

FIG. 1 is a schematic cross-sectional diagram of a modified polyimide/clay nanocomposite prepared in accordance with example embodiments;

FIG. 2 schematically illustrates a method for preparing modified polyimide/clay nanocomposites according to example embodiments; and

FIG. 3 is a differential scanning calorimeter (DSC) thermogram of a film composed of modified polyimide/clay nanocomposites, which was formed in Reference Example 1.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Hereinafter, example embodiments will be described in detail with reference to the attached drawings. Reference now should be made to the drawings, in which the same reference numerals are used throughout the different drawings to designate the same or similar components. In the drawings, the thicknesses and widths of layers are exaggerated for clarity. Example embodiments may, however, be embodied in many different forms and should not be construed as limited to the example embodiments set forth herein. Rather, these example embodiments are provided so that this disclosure will be thorough and complete, and will fully convey the scope of example embodiments to those skilled in the art.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood, that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments provide a composition for the preparation of modified polyimide/clay nanocomposites. Specifically, the composition of example embodiments comprises a modified polyamic acid terminated with reactive groups at both ends of the backbone and a layered clay compound.

The reactive end groups may independently have a structure derived from norbornene or maleamic acid.

The presence of the polyamic acid resin as a base resin and the layered clay compound provides excellent physical properties and improved thermal properties, e.g., low dielectric properties, low thermal expansion properties and high heat resistance, to the composition. The composition of example embodiments can be used to prepare modified polyimide/clay nanocomposites with excellent physical properties. For example, the modified polyimide/clay nanocomposites have a glass transition temperature of about 250° C. or above. In addition, the low coefficient of thermal expansion (about 20 ppm/° C. or below) of the base resin can be provided to the nanocomposites. The molecular chains of a modified polyimide resin, which is a polymerization product of the modified polyamic acid, are intercalated into the layered clay compound to achieve increased glass transition temperature and reduced coefficient of thermal expansion of the nanocomposites. Accordingly, the composition of example embodiments is suitable for use as a substrate material necessary for the packaging of highly integrated devices that are small in size and thickness and light in weight.

The modified polyamic acid may have a structure represented by Formula 1:

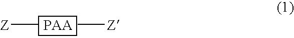

wherein PAA represents a polyamic acid, and Z and Z′, which may be identical to or different from each other, are independently

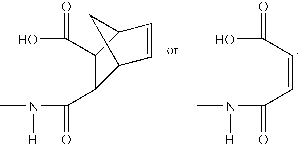

The modified polyimide may be polymerized from the modified polyamic acid terminated with end-groups derived from norbornene or maleamic acid at both ends of the backbone. The polymerization may be carried out by any suitable process well known in the art, and detailed description thereof is omitted. The number average molecular weight of the modified polyamic acid may be in the range of 1,000 to 90,000, but is not limited to this range.

Exemplary modified polyamic acids include those represented by Formula 2:

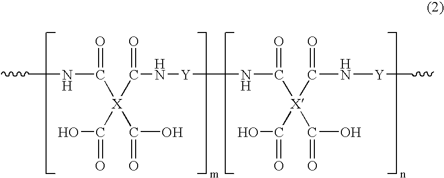

wherein X and X′, which may be identical to or different from each other, are independently an tetravalent organic group selected from the group consisting of

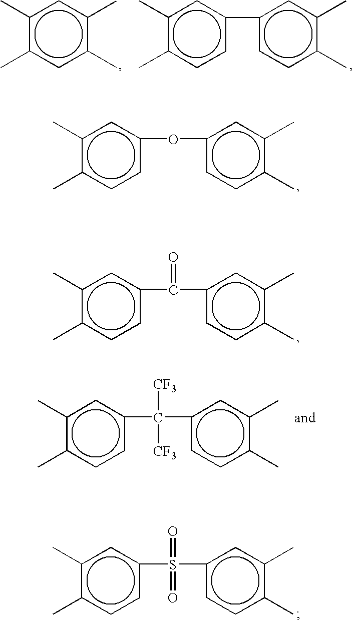

each Y is a divalent organic group selected from the group consisting of

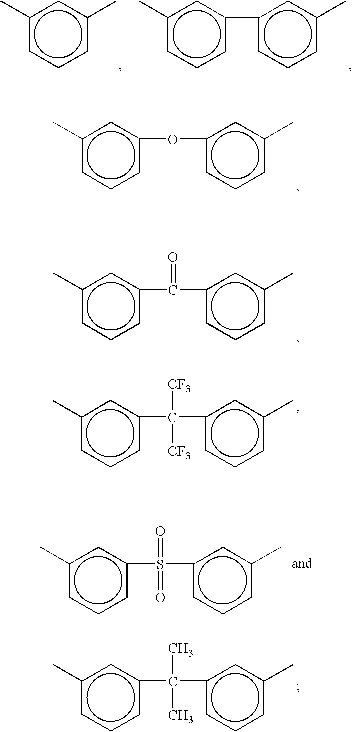

Z and Z′, which may be identical to or different from each other, are independently

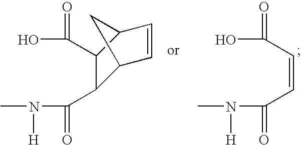

and m and n are independently from 1 to 1,000.

Specific examples of the modified polyamic acid of Formula 2 include, but are not limited to, those represented by Formulae 3 and 4:

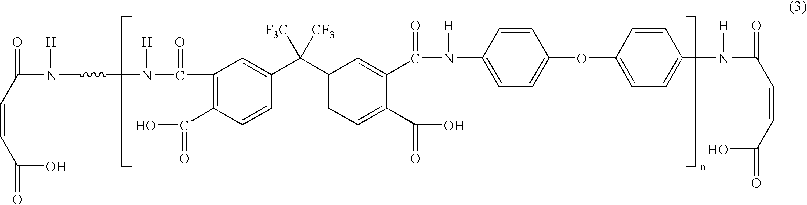

wherein n is from 1 to 1,000; and

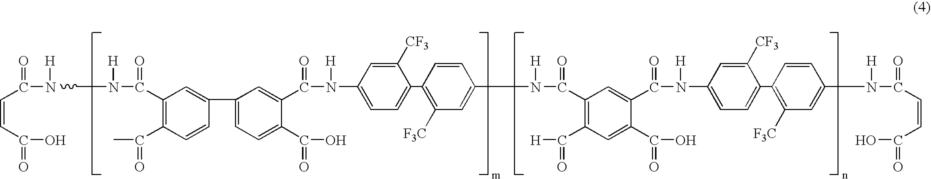

wherein m and n are independently from 1 to 1,000.

The layered clay compound refers to a silicate mineral containing exchangeable metal cations between its constituent layers. Examples of the layered clay compound include, but are not limited to, smectite clay minerals, such as sodium montmorillonite, magnesium montmorillonite, calcium montmorillonite, volkonskoite, hectorite and saponite, vermiculite, halloysite and swellable mica. Particularly preferred are montmorillonite, swellable mica and hectorite. The layered clay compounds may be natural or synthetic. The layered clay compounds may be used alone or as a mixture of two or more kinds thereof.

The exchangeable cations present between the layers of the layered clay compound are metal ions present on the crystal surfaces of the layered clay compound. The metal ions may be sodium and calcium ions. The metal ions are exchangeable with other cat ionic species, thus allowing the modified polyimide chains to be intercalated between the crystal layers of the layered clay compound. Wide-angle X-ray diffractometry revealed that the layered clay compound is preferably a layered silicate whose average interlayer spacing is 3 nm or above and a part or all of the layered clay particles are dispersed within a maximum of five layers.

The composition of example embodiments may comprise 98.5 to 99.999% by weight of the modified polyamic acid and 0.001 to 1.5% by weight of the layered clay compound. The use of the clay compound in an amount of less than 0.001% by weight does not contribute to a reduction in the coefficient of thermal expansion of a substrate to be produced using the composition. Meanwhile, the use of the clay compound in an amount of more than 1.5% by weight causes aggregation of the clay particles. This aggregation prevents the clay particles from being dispersed on a nanometer scale, and as a result, further improvement of the physical properties can not be expected.

Optionally, the composition of example embodiments may further comprise a cyanate ester containing a biphenyl moiety to achieve improved heat resistance. The cyanate ester may have a structure represented by Formula 5:

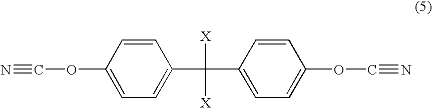

wherein each X is a methyl or fluoromethyl group.

The cyanate ester may be present in an amount of 0.1 to 30 parts by weight, based on 100 parts by weight of the modified polyamic acid and the clay compound. When the content of the cyanate ester is less than 0.1 parts by weight, improvement of heat resistance is insignificant. Meanwhile, when the content of the cyanate ester is more than 30 parts by weight, it is difficult to expect further improvement of heat resistance.

In addition to the modified polyamic acid and the clay compound, if required, the composition of example embodiments may further comprise at least one additive selected from solvents, fillers, softeners, plasticizers, lubricants, antistatic agents, colorants, antioxidants;, heat stabilizers, light stabilizers and UV absorbers, so long as the objects of example embodiments are achieved.

There is no particular limitation on the preparation method of the composition according to example embodiments. For example, the composition of example embodiments is prepared by directly compounding a predetermined amount of the modified polyamic acid resin with the layered clay compound, and if needed, a specified amount of the cyanate ester and/or at least one additive, and blending the mixture at room temperature or under heating. Alternatively, the components may be mixed in a solvent, followed by removal of the solvent to prepare the composition of example embodiments.

The composition of example embodiments can be used as a next-generation packaging material requiring high heat resistance, and low thermal expansion properties. The composition of example embodiments can be molded into a substrate or dissolved in a suitable solvent, to prepare a varnish for impregnation or coating applications. The applications of the composition according to example embodiments include laminates, printed boards, layers of multilayer substrates, resin-coated copper foils, copper-covered laminates, polyimide films, TAB films and prepregs, but are not limited thereto. For example, the composition of example embodiments is cast on a substrate and cured at a high temperature to form a thin film. The crosslinking of the reactive groups of the polyamic acid takes place during the high-temperature curing to form a stable liquid crystal alignment structure in the form of a rigid net, resulting in an improvement in mechanical properties.

Example embodiments provide a method for preparing modified polyimide/clay nanocomposites. Specifically, the method of example embodiments comprises the steps of a) mixing a layered clay compound with a modified polyamic acid terminated with reactive groups at both ends of the backbone, and b) thermally curing the mixture at a temperature above the glass transition temperature of the modified polyamic acid. According to the method of example embodiments, modified polyimide/clay nanocomposites may be prepared by adding a layered clay compound, and optionally, one or more additives (e.g., a cyanate ester) to a polyamic acid terminated with reactive groups derived from norbornene or maleamic acid at both ends of the backbone, blending the mixture, and curing the blend at a high temperature. The nanocomposites thus prepared have high heat resistance and low thermal expansion properties. Specifically, the nanocomposites have a high heat resistance of 250° C. or above and a low coefficient of thermal expansion of 2.0 ppm/° C. or below, thus satisfying the requirements for a next-generation packaging material.

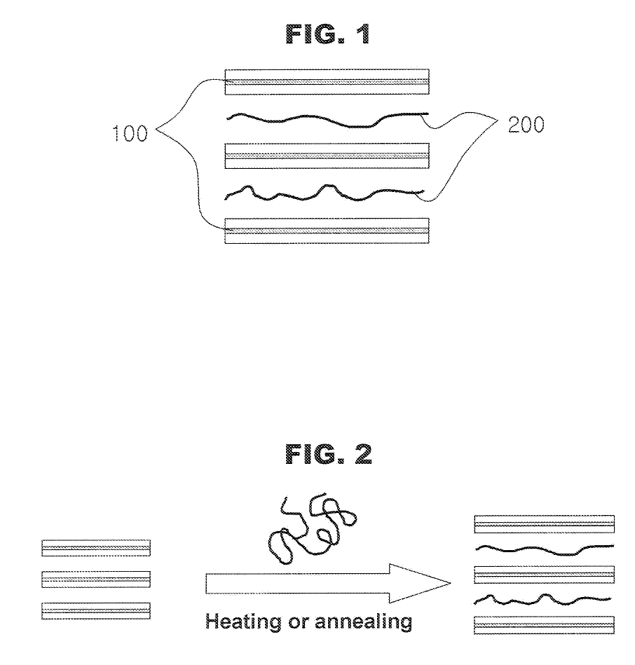

FIG. 1 is a schematic cross-sectional diagram of a modified polyimide/clay nanocomposite prepared by the method of example embodiments. In the modified polyimide/clay nanocomposite shown in FIG. 1, modified polyimide molecules 200, each of which has nadimide or maleimide groups at its both ends, are intercalated between respective layers 100 of the layered clay compound. For example, when the modified polyamic acid of Formula 3 is used to prepare nanocomposites, a modified polyimide polymer may be intercalated, represented by Formula 6:

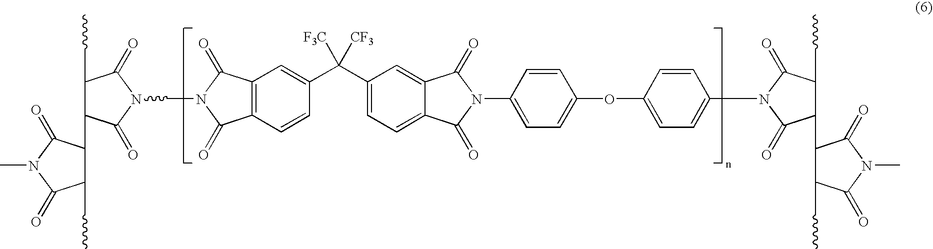

wherein n is from 1 to 1,000.

Also, when the modified polyamic acid of Formula 4 is used to prepare nanocomposites, a modified polyimide polymer may be intercalated, represented by Formula 7:

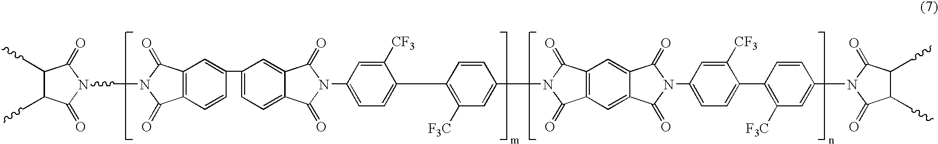

wherein m and n are independently from 1 to 1,000.

FIG. 2 schematically illustrates a method for preparing modified polyimide/clay nanocomposites according to example embodiments. A detailed description of the method according to example embodiments will be given below with reference to FIG. 2.

As illustrated in FIG. 2, a modified polyamic acid terminated with reactive groups at both ends of the backbone is mixed with a layered clay compound. The mixing may be done by well known techniques, e.g., sonication. Then, the mixture is annealed at a temperature above the glass transition temperature of the modified polyamic acid to prepare modified polyimide/clay nanocomposites. The crosslinking of the reactive end groups (Z and Z′ in Formula 1) of the polyamic acid proceeds during the high-temperature curing to extend the length of the polymer chains. As a result, a crosslinked modified polyimide is formed.

The structure of the modified polyamic acid is represented by Formula 1:

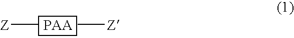

wherein PAA represents a polyamic acid, and Z and Z′, which may be identical to or different from each other, are independently

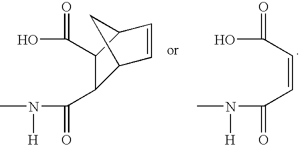

The number average molecular weight of the modified polyamic acid may be in the range of 1,000 to 90,000.

The mixing of the modified polyamic acid and the layered clay compound may be done in a solvent. Non-limiting examples of suitable solvents for use in example embodiments include N-methyl-2-pyrrolidone (NMP), N,N-dimethylacetamide, N,N-dimethylformamide, N,N-dimethylacetamide, N-methyl-2-pyrrolidone, 1,3-dimethyl-2-imadazolinone, N-methylcaprolactam, 1,2-dimethoxyethane, bis(2-methoxyethyl)ether, 1,2-bis(2-methoxyethyl)ethane, bis[2-(2-methoxyethoxy)ethyl]ether, tetrahydrofuran, 1,3-dioxane, 1,4-dioxane, pyrroline, picoline, dimethylsulfoxide, dimethylsulfone, tetramethylurea, hexamethylphosphoramide, phenol, m-cresol, m-cresylic acid, p-chlorophenol, anisole, methanol, benzene, toluene, and xylene. These solvents may be used, singly or as a mixture of two or more kinds thereof.

The modified polyamic acid may be represented by Formula 2:

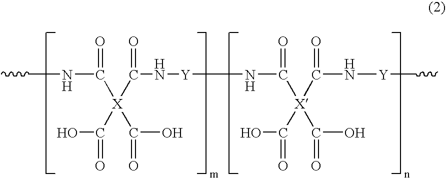

wherein X and X′, which may be identical to or different from each other, are independently an tetravalent organic group selected from the group consisting of

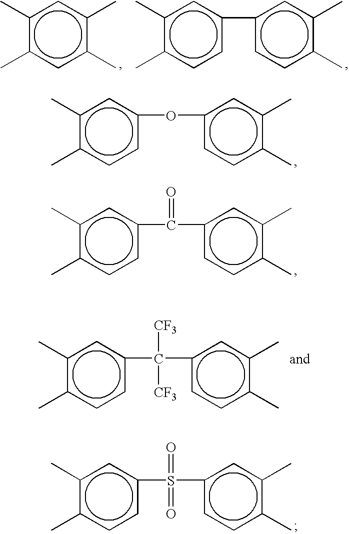

each Y is a divalent organic group selected from the group consisting of

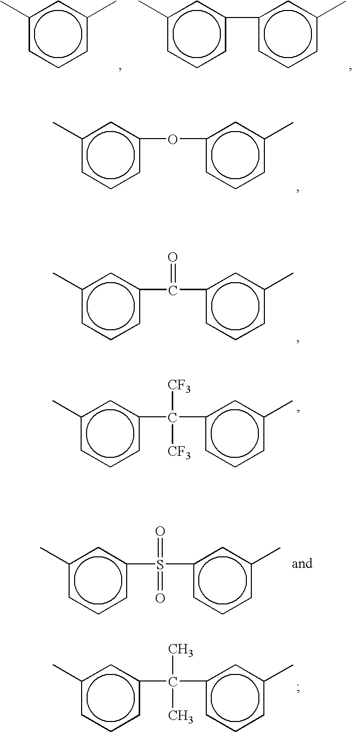

Z and Z′, which may be identical to or different from each other, are independently

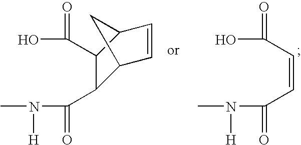

and m and n are independently from 1 to 1,000.

Specific examples of the modified polyamic acid of Formula 2 include those represented by Formulae 3 and 4:

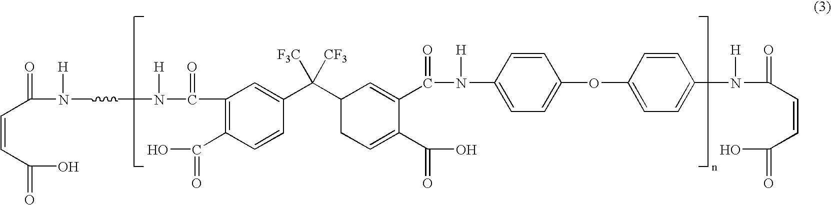

wherein n is from 1 to 1,000; and

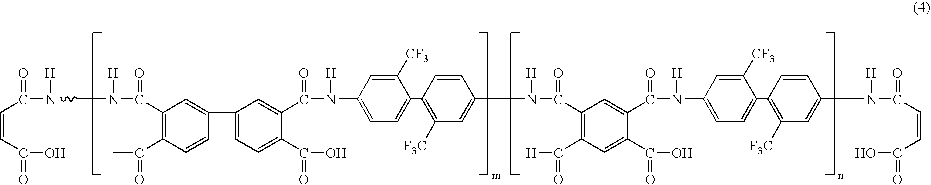

wherein m and n are independently from 1 to 1,000.

The layered clay compound may be selected from the group consisting of smectite clay minerals, such as sodium montmorillonite, magnesium montmorillonite, calcium montmorillonite, volkonskoite, hectorite and saponite, vermiculite, halloysite, swellable mica and mixtures thereof.

A cyanate ester may be added to the modified polyamic acid before mixing with the layered clay compound, followed by blending.

The cyanate ester may be represented by Formula 5:

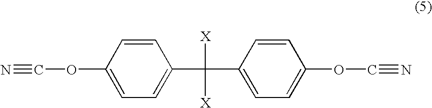

wherein each X is a methyl or fluoromethyl group.

In this case, the cyanate ester is added to a solution of the modified polyamic acid, and is then mixed with the clay compound.

Example embodiments provide a substrate comprising the composition. The substrate may be a printed board, a copper foil, a copper-covered laminate or a prepreg. The prepreg may be produced by impregnating the modified polyimide/clay nanocomposites with a base material (e.g., a glass fabric), curing the impregnated nanocomposites, and forming the cured nanocomposites into a sheet.

The modified polyimide/clay nanocomposites may be formed on a metal foil to produce a copper clad laminate (CCL), particularly, a flexible CCL. At this time, the composition of example embodiments may be coated on a metal foil to produce a substrate (preferably, a flexible substrate). The coating may be performed using a roll coater, die coater, comma coater, gravure coater, or the like. The metal foil may be composed of a suitable metal, preferably copper (Cu), aluminum (Al), iron (Fe) or nickel (Ni), and more preferably copper or aluminum.

The substrate of example embodiments may be produced by processing the composition into a thin film. Examples of such processing methods include, but are not limited to, the following methods: i) the composition of example embodiments is extruded in an extruder and passed through a die to form a film (extrusion molding); ii) the composition of example embodiments is dissolved or dispersed in a solvent and cast into a film (cast molding); and an inorganic substrate (e.g., a glass substrate) or a fabric-like substrate is dipped in a varnish, which is obtained by dissolving or dispersing the composition of example embodiments in a solvent, and is then molded into a film (dip molding). Extrusion molding and cast molding are particularly preferred in the production of thin multilayer substrates. The modified polyimide/clay nanocomposites may also be utilized as an insulating material.

Hereinafter, example embodiments will be described in detail with reference to Examples. These Examples are set forth to illustrate example embodiments, but should not be construed as the limit of example embodiments.

### EXAMPLES

### Synthesis Example 1

### Synthesis of Modified Polyamic Acid (mPI01)

In this example, a modified polyamic acid (mPI01) was synthesized according to the following Reaction Scheme 1.

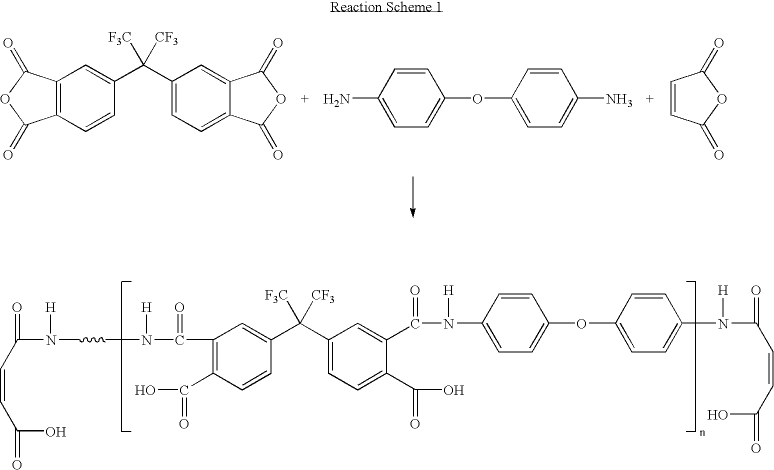

First, 10.01 g of oxydianiline (ODA) and 70.85 g of NMP were sequentially introduced into a 1 L round-bottom jacketed reactor. After completely dissolving the mixture, 18.88 g of 4,4′-hexafluoroisopropylidene)diphthalic anhydride (6FDA) was slowly added while maintaining the temperature of the reactor at 0-5° C. The resulting solution was allowed to sufficiently react with stirring for 2 hours. 1.47 g of 5-norbornene-2,3-dicarboxylic anhydride (NDA) was slowly added to the reaction solution, followed by stirring at room temperature for 16 hours to afford the modified polyamic acid as a solution. Poly(amic acid) solution of which solid content is 25 wt % was synthesized.

### Synthesis Example 2

### Synthesis of Modified Polyamic Acid (mPI02)

In this example, a modified polyamic acid (mPI02) having maleamic acid groups at both ends of the backbone and liquid crystallinity was synthesized.

Formula x

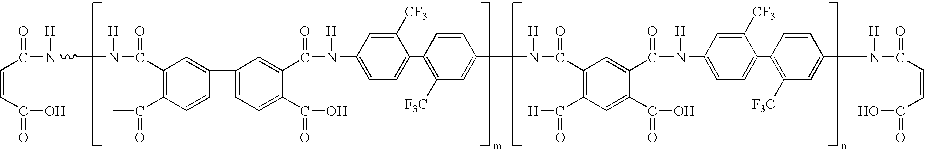

First, 9.61 g of 2,2′-bis(trifluoromethyl)benzidine (BTFB) and 51.1 g of NMP were sequentially introduced into a 1 L round-bottom jacketed reactor. After completely dissolving the mixture, 2.78 g of pyromellitic dianhydride (PMDA) and 3.75 g of 4,4′-biphthalic anhydride (BPDA) were slowly added while maintaining the temperature of the reactor at 0-5° C. Stirring was continued to dissolve the mixture. The resulting solution was allowed to sufficiently react with stirring for 2 hours. 0.38 g of maleic anhydride was slowly added to the reaction solution, followed by stirring at room temperature for 16 hours to afford the modified polyamic acid as a solution.

### Example 1

0.278 g of layered sodium-montmorillonite (Na-MMT) was homogeneously dispersed in 10 g of polyamic acid solution prepared in Synthesis Example 2 by sonication to prepare a coating solution of modified polyimide/clay nanocomposites. Subsequently, the coating solution was applied to a silicon wafer and cured in an electronic furnace with a multi-step process: heating rating 10° C./min up to 300° C. and heating at 300° C. for 2 hours in nitrogen ambient to form a film. The resulting silicon wafer substrate was treated with an acidic solution consisting of 2-wt % aqueous hydrofluoric acid solution to separate the film from the silicon wafer. The coefficient of thermal expansion (CTE) of the film was measured using a thermomechanical analyzer (TMA) (TMA 2940, TA instruments) and is shown in Table 1.

### Comparative Example 1

A film, was formed in the same manner as in Example 1 except that only the polyamic acid prepared in Synthesis Example 1 was used without the addition of layered sodium-montmorillonite (Na-MMT) as a clay compound. The coefficient of thermal expansion of the film was measured by the procedure described in Example 1 and is shown in Table 1.

TABLE 1

| | CTE (ppm/° C.) |
|---|---|
| Comparative Example 1 | 41.24 |
| Example 1 | 18.2 |

As can be seen from Table 1, the coefficient of thermal expansion of the film formed in Example 1 was about 50% lower than that of the film formed in Comparative Example 1. These results demonstrate that the presence of the clay compound contributed to a reduction in coefficient of thermal expansion.

### Reference Example 1

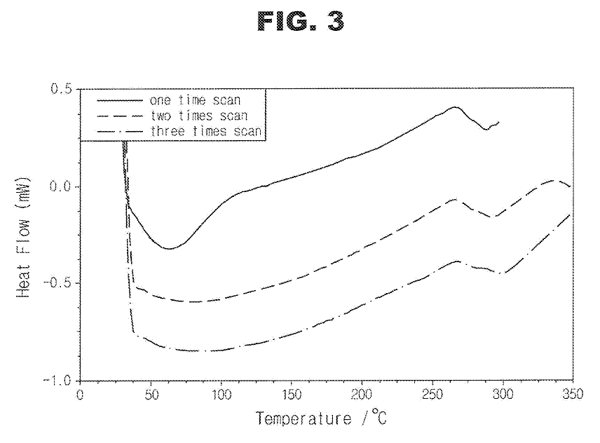

0.747 g 2,2-bis(4-cyanatophenyl) propane (TCI) as a cyanate ester was added to 10 g polyamic acid solution prepared in Synthesis Example 1. The mixture was dissolved in N-methyl-2-pyrrolidone (NMP) to prepare a coating solution. Subsequently, the coating solution was applied to a silicon wafer and cured in an electronic furnace with a multi-step process: heating rating 10° C./min up to 300° C. and heating at 300° C. for 2 hours in nitrogen ambient to form a film. The resulting silicon wafer substrate was treated with a 2-wt % aqueous hydrofluoric acid solution to separate the film from the silicon wafer. The coefficient of thermal expansion (CTE) of the film was measured using a differential scanning calorimeter (DSC) three times. The results are shown in FIG. 3. In a typical differential scanning calorimetry (DSC) thermogram, glass transition temperature (T_{g}) is defined as the point at which the calorie curve is inclined toward the endothermic region and is maintained constant. No glass transition temperature (T_{g}) was observed throughout the three scanning cycles.

### Comparative Example 2

0.747 g of 2,2′-bis(4-cyanatophenyl)-1,1,3,3,3-hexafluoropropane (synthesized in situ) as a hexafluorocyanate ester was added to 10 g of the polyamic acid solution prepared in Synthesis Example 1. The mixture was dissolved in N-methyl-2-pyrrolidone (NMP) to prepare a coating solution. Subsequently, the coating solution was applied to a silicon wafer and cured an electronic furnace with a multi-step process: heating rating 10° C./min up to 300° C. and heating at 300° C. for 2 hours in nitrogen ambient to form a film. The resulting silicon wafer substrate was treated with a 2-wt % aqueous hydrofluoric acid solution to separate the film from the silicon wafer. The coefficient of thermal expansion (CTE) of the film was measured using a thermomechanical analyzer (TMA) (TMA 2940, TA Instruments) and is shown in Table 2.

### Examples 2 and 3

0.747 g of 2,2′-bis(4-cyanatophenyl)-1,1,1,3,3,3-hexafluoropropane (synthesized in situ) as a hexafluorocyanate ester was added to 10 g of the polyamic acid solution prepared in Synthesis Example 1. The mixture was dissolved in NMP to prepare a coating solution. 0.02.7 g (Example 2) or 0.079 g (Example 3) of Na-MMT was homogeneously dispersed in the solution by sonication to prepare a coating solution. Subsequently, the coating solution was applied to a silicon wafer and cured in an electronic furnace with a multi-step process: heating rating 10° C./min up to 300° C. and heating at 300° C. for 2 hours in nitrogen ambient to form a film. The resulting silicon wafer substrate was treated with a 2-wt % aqueous hydrofluoric acid solution to separate the film from the silicon wafer. The coefficient of thermal expansion (CTE) of the film was measured using a thermomechanical analyzer (TMA) (TMA 2940, TA Instruments) and is shown in Table 2.

TABLE 2

| | CTE (ppm/° C.) |
|---|---|
| Comparative Example 2 | 41.24 |
| Example 2 | 30.11 |
| Example 3 | 30.05 |

As is evident from Table 2, the coefficients of thermal expansion of the films formed in Examples 2 and 3 were about 25% lower than the coefficient of thermal expansion of the film formed in Comparative Example 2. These results demonstrate that the addition of the clay compound contributed to a reduction in coefficient of thermal expansion.

### Comparative Example 3

0.747 g a cyanate ester was added to 2.5 g of the polyamic acid prepared in Synthesis Example 2. The mixture was dissolved in N-methyl-2-pyrrolidine (NMP) to prepare a coating solution. Subsequently, the coating solution was applied to a silicon wafer and cured an electronic furnace with a multi-step process: heating rating 10° C./min up to 300° C. and heating at 300° C. for 2 hours in nitrogen ambient to form a film. The resulting silicon wafer substrate was treated with a 2 wt % aqueous hydrofluoric acid solution to separate the film from the silicon wafer. The coefficient of thermal expansion (CTE) of the film was measured using a thermomechanical analyzer (TMA) (TMA 2940, TA Instruments) and is shown in Table 3.

### Examples 4-6

5.46 g of a cyanate ester was added to 18.28 g by weight of the polyamic acid solution prepared in Synthesis Example 2. The mixture was dissolved in NMP to prepare a coating solution. 0.027 g (Example 4), 0.054 g (Example 5) or 0.079 g (Example 6) of Na-MMT was homogeneously dispersed in the solution by sonication to prepare a coating solution. Subsequently, the coating solution was applied to a silicon wafer and cured in an electronic furnace with a multi-step process: heating rating 10° C./min up to 300° C. and heating at 300° C. for 2 hours in nitrogen ambient to form a film. The resulting silicon wafer substrate was treated with a 2-wt % aqueous hydrofluoric acid solution to separate the film from the silicon wafer. The coefficient of thermal expansion (CTE) of the film was measured using a thermomechanical analyzer (TMA) (TMA 2940, TA Instruments) and is shown in Table 3.

TABLE 3

| | CTE (ppm/° C.) |
|---|---|
| Comparative Example 3 | 50.71 |
| Example 4 | 48.92 |
| Example 5 | 31.57 |
| Example 6 | 29.15 |

As is evident from Table 3, the coefficients of thermal expansion of the films formed in Examples 4, 5 and 6 were as much as about 40% lower than the coefficient of thermal expansion of the film formed in Comparative Example 3. These results demonstrate that the addition of the clay compound contributed to a reduction in coefficient of thermal expansion.

Although example embodiments have been disclosed for illustrative purposes, those skilled in the art will appreciate that various modifications, additions and substitutions are possible, without departing from the scope and spirit of the accompanying claims.

What is claimed is:

1. A composition for preparing modified polyimide/clay nanocomposites, comprising a modified polyamic acid terminated with reactive groups at both ends of the backbone and a layered clay compound wherein the modified polyamic acid is represented by Formula 1: 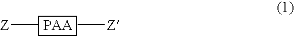
wherein PAA represents a polyamic acid, and Z and Z′, which are identical to or different from each other, are independently

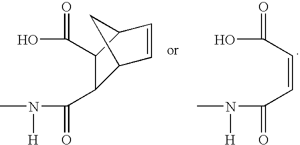

2. The composition according to claim 1, wherein the modified polyamic acid has a number average molecular weight of 1,000 to 90,000.

3. The composition according to claim 1, wherein the modified polyamic acid is represented by Formula 2: 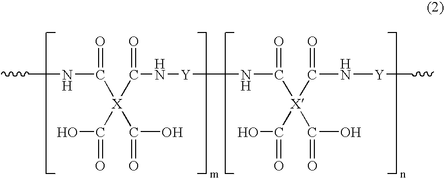
wherein X and X′, which are identical to or different from each other, are independently an tetravalent organic group selected from the group consisting of 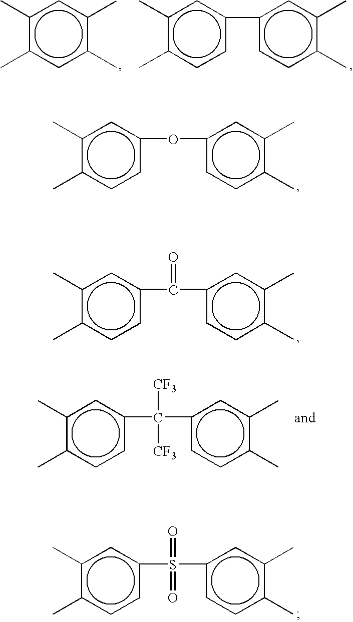
each Y is a divalent organic group selected from the group consisting of 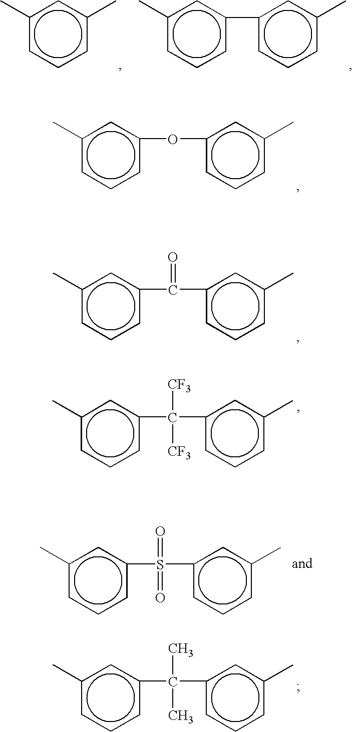
Z and Z′, which are identical to or different from each other, are independently 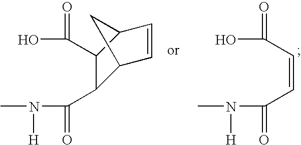
and m and n are independently from 1 to 1,000.

4. The composition according to claim 3, wherein the modified polyamic acid is represented by Formula 3 or 4: 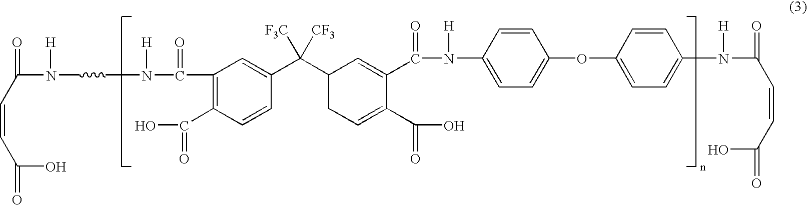
wherein n is from 1 to 1,000; or 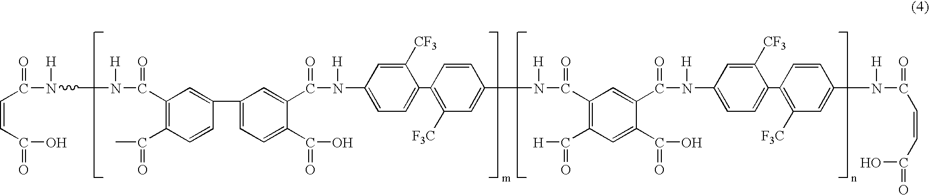
wherein m and n are independently from 1 to 1,000.

5. The composition according to claim 1, wherein the layered clay compound is selected from the group consisting of smectite clay minerals, including sodium montmorillonite, magnesium montmorillonite, calcium montmorillonite, volkonskoite, hectorite and saponite, vermiculite, halloysite, swellable mica, and mixtures thereof.

6. The composition according to claim 1, wherein the modified polyamic acid is present in an amount of 98.5 to 99.999% by weight and the layered clay compound is present in an amount of 0.001 to 1.5% by weight.

7. The film cured at 300° C. for 2 hours according to claim. 1, wherein the polyamic acid and clay are composed by the composition mentioned in claim 6.

8. The composition according to claim 1, further comprising a cyanate ester represented by Formula 5: 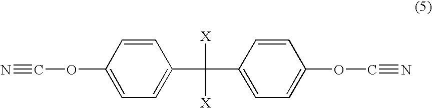
wherein each X is a methyl or fluoromethyl group.

9. The composition according to claim 7, wherein the cyanate ester is present in an amount of 0.1 to 30 parts by weight, based on 100 parts by weight of the modified polyamic acid and the clay compound.

10. A method for preparing modified polyimide/clay nanocomposites, the method comprising the steps of a) mixing a layered clay compound with a modified polyamic acid terminated with reactive groups at both ends of the backbone, and b) annealing the mixture at a temperature above the glass transition temperature of the modified polyamic acid wherein the modified polyamic acid is represented by Formula 1: 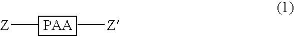
wherein PAA represents a polyamic acid, and Z and Z′, which are identical to or different from each other, are independently

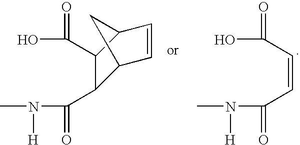

11. The method according to claim 9, wherein the modified polyamic acid is represented by Formula 2: 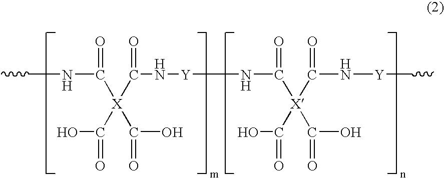
wherein X and X′, which are identical to or different from each other, are independently an tetravalent organic group selected from the group consisting of 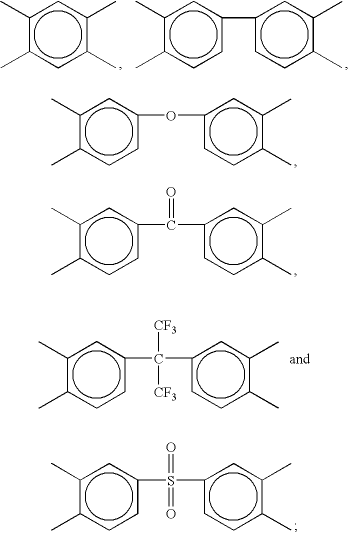
each Y is a divalent organic group selected from the group consisting of 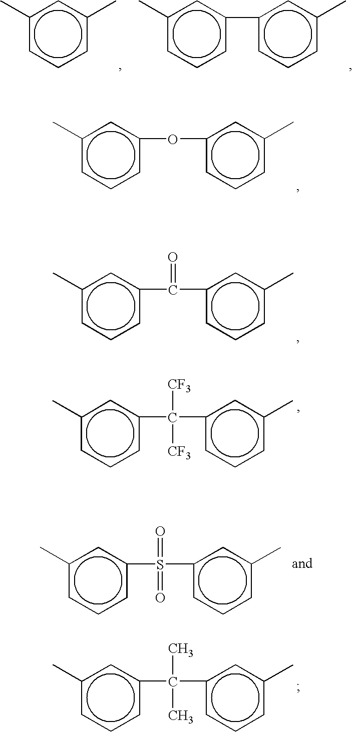
Z and Z′, which are identical to or different from each other, are independently 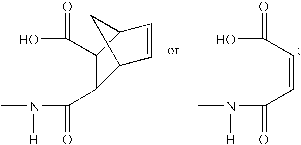
and m and n are independently from 1 to 1,000.

12. The method according to claim 10, wherein the modified polyamic acid is represented by Formula 3 or 4: 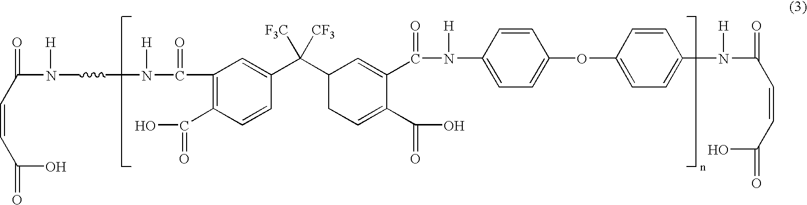
wherein n is from 1 to 1,000; or 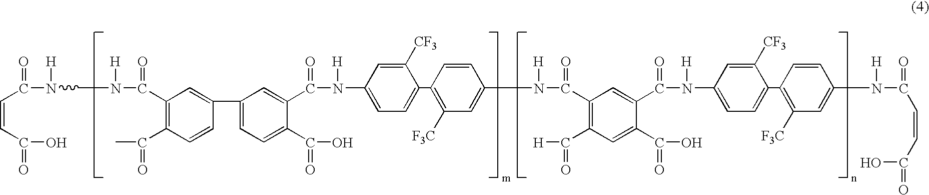
wherein m and n are independently from 1 to 1,000.

13. The method according to claim 9, wherein the layered clay compound is selected from the group consisting of smectite clay minerals, including sodium montmorillonite, magnesium montmorillonite, calcium montmorillonite, volkonskoite, hectorite and saponite, vermiculite, halloysite, swellable mica, and mixtures thereof.

14. The method according to claim 9, wherein the layered clay compound is mixed with the modified polyamic acid by sonication.

15. The method according to claim 9, further comprising the step) of adding a cyanate ester to the modified polyamic acid prior to step a) wherein the cyanate ester is represented by Formula 5: 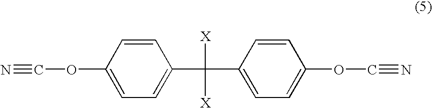
wherein each X is a methyl or fluoromethyl group.

16. The film cured at 300° C. for 2 hours according to claim 1, wherein the polyamic acid and cyanate ester are mixed by the method mentioned in claim 6.

17. A substrate comprising the composition according to claim 1.

18. The substrate according to claim 15, wherein the substrate is a printed board, a copper foil, a copper-covered laminate or a prepreg.

19. The substrate according to claim 18, wherein the substrate is a copper clad laminate (CCL) or a flexible CCL.
